(19) United States
(12) Patent Application Publication
(10) Pub. No.: US 2024/0305137 A1
(43) Pub. Date: Sep. 12, 2024

(54) WIRELESS POWER TRANSMISSION DEVICE, WIRELESS POWER RECEPTION DEVICE, ACCESSORY DEVICE, AND METHOD THEREOF

(71) Applicant: Samsung Electronics Co., Ltd., Suwon-si (KR)

(72) Inventors: Beomwoo GU, Suwon-si (KR); Minbeom KO, Suwon-si (KR); Jaeseok PARK, Suwon-si (KR); Jaehyun PARK, Suwon-si (KR); Kangho BYUN, Suwon-si (KR); Sungku YEO, Suwon-si (KR)

(21) Appl. No.: 18/582,066

(22) Filed: Feb. 20, 2024

Related U.S. Application Data
(63) Continuation of application No. PCT/KR2024/001618, filed on Feb. 2, 2024.

(30) Foreign Application Priority Data
Mar. 10, 2023 (KR) 10-2023-0031986

(51) Int. Cl. H02J 50/12; H02J 50/00; H02J 50/40; H02J 50/80

(52) U.S. Cl. CPC H02J 50/12; H02J 50/005; H02J 50/40; H02J 50/80

(57) ABSTRACT

According to an embodiment, a wireless power reception device may include: a housing, a first coil, and a power processing circuit configured to process power wirelessly received from the outside through the first coil. The housing may include a first surface facing a first direction, a second surface facing a second direction opposite the first direction, and a third surface surrounding a space between the first surface and the second the surface. The width of the third surface may be smaller than the width of the first surface. The first coil may be disposed in a region including a region substantially parallel to the third surface.

### CROSS-REFERENCE TO RELATED APPLICATIONS

This application is a continuation of International Application No. PCT/KR2024/001618 designating the United States, filed on Feb. 2, 2024, in the Korean Intellectual Property Receiving Office and claiming priority to Korean Patent Application No. 10-2023-0031986, filed on Mar. 10, 2023, in the Korean Intellectual Property Office, the disclosures of each of which are incorporated by reference herein in their entireties.

### BACKGROUND

### Field

The disclosure relates to a wireless power transmission device, a wireless power reception device, an accessory device, and a method thereof.

### Description of Related Art

A wireless power reception device may wirelessly receive power from a wireless power transmission device while being adjacent to the wireless power transmission device or mounted on the wireless power transmission device. Wireless power transmission technology may refer to a method of transmitting power using an electromagnetic field induced in coils so that a current may be supplied to a transmission coil to generate an electromagnetic field and an induced current may be obtained in a reception coil by the generated electromagnetic field, thereby supplying electrical energy. The magnitude of the received power may vary depending on the area (or number of turns) of the reception coil of the wireless power reception device.

A wireless power transmission/reception system has an important issue of reducing power loss and increasing power transmission efficiency. The wireless power transmission device and the wireless power reception device may transmit and receive data related to wireless charging. It is necessary to harmonize the transmission and reception of data and wireless charging between the wireless power transmission device and the wireless power reception device.

### SUMMARY

According to an example embodiment, a wireless power reception device may include: a housing, a first coil, and a power processing circuit configured to process power wirelessly received from the outside through the first coil. The housing may include a first surface facing a first direction, a second surface facing a second direction opposite the first direction, and a third surface surrounding a space between the first surface and the second the surface. The width of the third surface may be less than a width of the first surface. The first coil may be disposed in a region including a region substantially parallel to the third surface

According to an example embodiment, a wireless power transmission device may include: a power amplifier, a first coil configured to wirelessly transmit second power to a wireless power reception device comprising wireless power reception circuitry, based on first power provided from the power amplifier, a harmonic filter configured to filter the first power provided to the first coil, a secondary inductor magnetically coupled to a resonant inductor included in the harmonic filter, a second coil electrically connected to the secondary inductor and configured to transmit a first signal to the outside, and a modulator connected to the second coil.

According to an example embodiment, an accessory device may include: a cover configured to cover a first external device, a seat on which the first external device is mounted, a first coil disposed substantially parallel to the seat, a power processing circuit configured to process power wirelessly received from the first external device through the first coil, and a modulator configured to adjust the load connected to the first coil in order for the first external device to recognize a signal.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIGS. 1A, 1B, 1C and 1D are diagrams illustrating various devices included in a wireless charging system according to an embodiment;

FIG. 2 is a perspective view illustrating devices included in a wireless charging system according to an embodiment;

FIG. 3 is a diagram illustrating operations between devices included in a wireless charging system according to an embodiment;

FIGS. 4A and 4B are diagrams illustrating an arrangement of coils of a wireless power reception device according to an embodiment;

FIGS. 5A, 5B and 5C are diagrams illustrating an arrangement of coils of a wireless power transmission device according to an embodiment;

FIGS. 6A and 6B are diagrams illustrating an accessory device according to an embodiment;

FIG. 7 is a block diagram illustrating an example configuration of devices included in a wireless charging system according to an embodiment;

FIG. 8 is a block diagram illustrating an example configuration of a wireless power transmission device according to an embodiment;

FIG. 9 is a circuit diagram illustrating an example configuration of a wireless power transmission device according to an embodiment;

FIG. 10 is a circuit diagram illustrating an example configuration of a wireless power transmission device according to an embodiment;

FIG. 11 is a circuit diagram illustrating an example configuration of a wireless power reception device according to an embodiment;

FIG. 12 is a circuit diagram illustrating an example configuration of a wireless power reception device according to an embodiment;

FIGS. 13A, 13B and 13C are diagrams illustrating example arrangements of coils according to an embodiment;

FIGS. 14A and 14B are diagrams illustrating power transmission between a wireless power transmission device and a wireless power reception device, and communication waveforms thereof according to an embodiment;

FIG. 15 is a diagram illustrating power transmission between an accessory device and a wireless power reception device, and communication waveforms according to an embodiment;

FIG. 16 is a diagram illustrating communication waveforms of communication through an accessory device according to an embodiment;

FIGS. 17A and 17B are perspective views illustrating an arrangement of coils of a wireless power reception device according to an embodiment;

FIGS. 18A and 18B are perspective views illustrating an arrangement of coils of a wireless power reception device according to an embodiment;

FIG. 19 is a diagram illustrating an arrangement of coils of a wireless power transmission device according to an embodiment; and

FIG. 20 is a perspective view illustrating a keyboard included in an accessory device according to an embodiment.

### DETAILED DESCRIPTION

The figures include diagrams illustrating devices included in a wireless charging system according to an embodiment. The configurations explained in detail may be illustrated to be emphasized, and unnecessary descriptions related to the respective drawings may be omitted. Accordingly, the various example embodiments in may not be separate embodiments from each other, and the various example embodiments may be organically combined with each other. For example, in the case where the first drawing includes a first configuration but does not include a second configuration and where the second drawing does not include the first configuration but includes the second configuration, the first drawing and the second drawing are intended to emphasize and explain the first configuration and the second configuration, respectively, so those skilled in the art may understand that an embodiment including both the first configuration in the first drawing and the second configuration in the second drawing is possible.

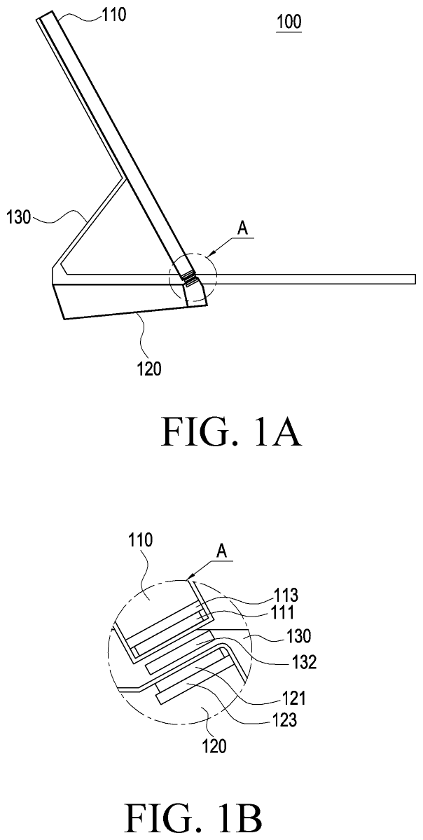

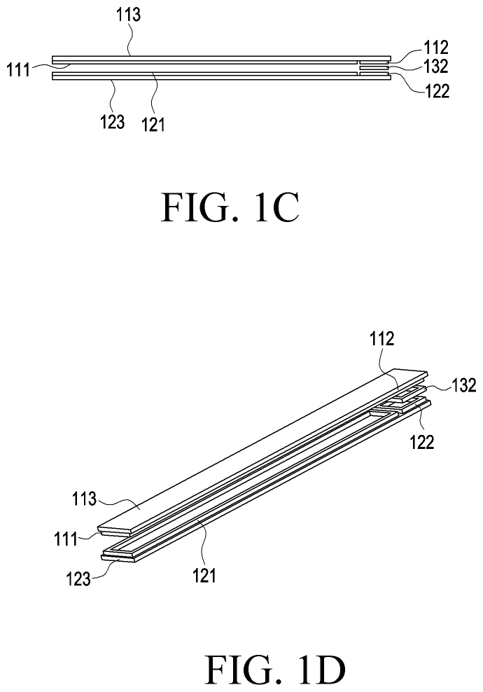

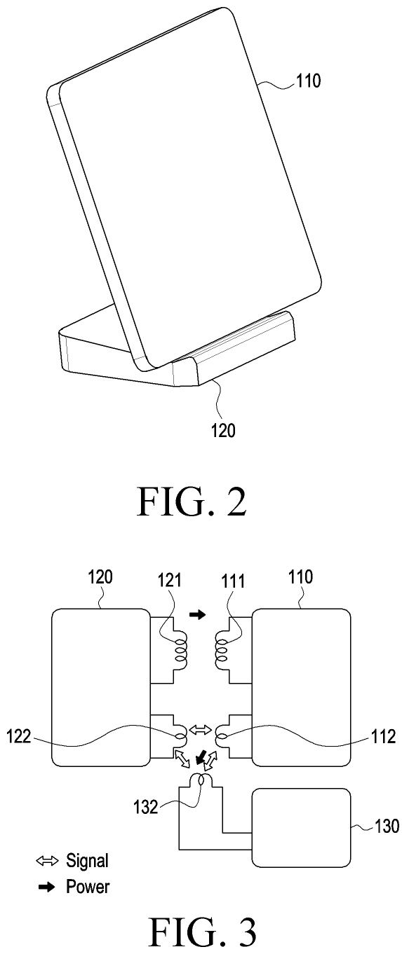

FIGS. 1A, 1B, 1C and 1D are diagrams illustrating various devices included in a wireless charging system according to an embodiment. FIG. 2 is a perspective view illustrating devices included in a wireless charging system according to an embodiment. FIG. 3 is a diagram illustrating operations between devices included in a wireless charging system according to an embodiment.

FIG. 1A is a side view (e.g., side projection view) of a wireless power reception device 110, a wireless power transmission device 120, and an accessory device 130. Referring to FIG. 1A, a wireless power transmission and reception system 100 according to an embodiment may include a wireless power transmission device 120. For example, the wireless power transmission device 120 may be implemented as a charging dock, but the type of the wireless power transmission device 120 is not limited. The wireless power transmission and reception system 100 may include a wireless power reception device 110 that wirelessly receives power from the wireless power transmission device 120. For example, the wireless power reception device 110 may be implemented as a mobile device or a tablet device, but the type of the wireless power reception device 110 is not limited. The wireless power transmission and reception system 100 may include an accessory device 130 on which the wireless power reception device 110 is mounted. For example, the accessory device 130 may be implemented as a cover device, but the type of the accessory device 130 is not limited. According to an embodiment, the wireless power transmission and reception system 100 may not include the accessory device 130.

According to an embodiment, the wireless power transmission device 120 may be implemented in a form enabling an external device to be mounted thereon. Referring to FIGS. 1A, 1B, 1C and 1D, the accessory device 130 may be mounted on the wireless power transmission device 120. For example, the wireless power reception device 110 may be mounted on the accessory device 130, and the accessory device 130 may be mounted on the wireless power transmission device 120. According to an embodiment, in the state in which the wireless power reception device 110 is mounted on the accessory device 130 and in which the accessory device 130 is mounted on the wireless power transmission device 120, the wireless power reception device 110 may wirelessly receive power from the wireless power transmission device 120. FIG. 2 is a perspective view of the wireless power reception device 110 and the wireless power transmission device 120. The wireless power reception device 110 may be mounted on the wireless power transmission device 120. According to an embodiment, the wireless power reception device 110 may wirelessly receive power from the wireless power transmission device 120 while being mounted directly on the wireless power transmission device 120, instead of being mounted on the accessory device 130.

The wireless power transmission device 120 may include a coil capable of generating an induced magnetic field when current flows therethrough. The process in which the wireless power transmission device 120 generates an induced magnetic field may be expressed that the wireless power transmission device 120 wirelessly transmits power. In addition, the wireless power reception device 110 may include a coil that generates induced electromotive force by the magnetic field that varies in magnitude depending on the time formed around the coil. The process of generating induced electromotive force through the coil may be expressed that the wireless power reception device 110 wirelessly receives power.

In the disclosure, a specific operation performed by the wireless power transmission device 120 may indicate a specific operation performed by a variety of hardware included in the wireless power transmission device 120, for example, a control circuit such that a processor (e.g., a transmission IC and/or a micro-controlling unit (MCU)) and a coil. The case where the wireless power transmission device 120 performs a specific operation may indicate that the processor controls other hardware to perform a specific operation. The case where the wireless power transmission device 120 performs a specific operation may also indicate causing a processor or other hardware to perform a specific operation by executing at least one instruction for performing a specific operation stored in a storage circuit (e.g., memory) of the wireless power transmission device 120. The processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

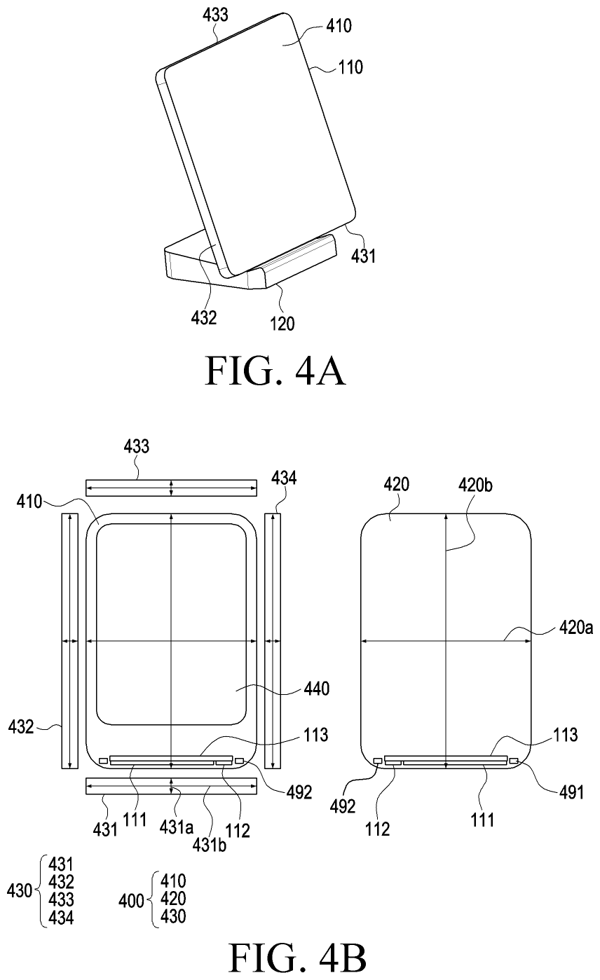

Referring to FIGS. 1A, 1B, 1C and 1D, according to an embodiment, the wireless power reception device 110 may wirelessly receive power through a first coil 111 disposed substantially parallel to the side surface. The first coil 111 may include a coil for transmitting and receiving power. The side surface may be a surface surrounding the space between a front surface and a rear surface. For example, the wireless power reception device 110 may wirelessly receive power through the first coil 111 disposed substantially parallel to a lower side surface of the side surface. The front surface, rear surface, and side surface will be described in greater detail below with reference to FIGS. 4A and 4B.

FIG. 1B is an enlarged projection view of the portion A in FIG. 1A.

Referring to FIG. 1B, according to an embodiment, the wireless power transmission device 120 may include a first coil 121. The first coil 121 may be a coil for transmitting and receiving power. The first coil 121 may be used to wirelessly transmit power to the outside. The wireless power transmission device 120 may wirelessly transmit power to the outside through the first coil 121. For example, referring to FIG. 3, the wireless power transmission device 120 may wirelessly transmit power to the wireless power reception device 110 through the first coil 121.

Referring to FIG. 1B, according to an embodiment, the wireless power reception device 110 may include a first coil 111. The first coil 111 may be used to wirelessly receive power from the outside. The wireless power reception device 110 may wirelessly receive power from the outside through the first coil 111. For example, referring to FIG. 3, the wireless power reception device 110 may wirelessly receive power from the wireless power transmission device 120 through the first coil 111.

FIG. 1B is a side view illustrating the arrangement of coils. Referring to FIG. 1B, according to an embodiment, the accessory device 130 may include a coil 132. The coil 132 may be used to wirelessly receive power from the outside. The accessory device 130 may wirelessly receive power from the outside through the coil 132. For example, referring to FIG. 3, the accessory device 130 may wirelessly receive power from the wireless power reception device 110 through the coil 132.

FIG. 1C is a front view illustrating the arrangement of coils. FIG. 1D is a perspective view illustrating the arrangement of coils. Referring to of FIGS. 1C and 1D, according to an embodiment, the wireless power transmission device 120 may include a first coil 121 and a second coil 122. The second coil 122 may be a coil for transmitting and receiving signals. The signals may include data. The second coil 122 may be used to transmit signals to the outside. The wireless power transmission device 120 may transmit signals to the outside through the second coil 122. For example, referring to FIG. 3, the wireless power transmission device 120 may transmit signals to the wireless power reception device 110 through the second coil 122. For example, referring to FIG. 3, the wireless power transmission device 120 may transmit signals to the accessory device 130 through the second coil 122. For example, the wireless power transmission device 120 may perform communication using harmonic components generated by a power amplifier, which will be described later. The second coil 122 of the wireless power transmission device 120 may be used to receive signals from the outside. The wireless power transmission device 120 may receive signals from the outside through the second coil 122. For example, referring to FIG. 3, the wireless power transmission device 120 may receive signals from the wireless power reception device 110 through the second coil 122. For example, referring to FIG. 3, the wireless power transmission device 120 may receive signals from the accessory device 130 through the second coil 122.

Referring to FIGS. 1C and 1D, according to an embodiment, the wireless power reception device 110 may include a first coil 111 and a second coil 112. The second coil 112 may be a coil for transmitting and receiving signals. The second coil 112 may be used to receive signals from the outside. The wireless power reception device 110 may receive signals from the outside through the second coil 112. For example, referring to FIG. 3, the wireless power reception device 110 may receive signals from the wireless power transmission device 120 through the second coil 112. For example, referring to FIG. 3, the wireless power reception device 110 may receive signals from the accessory device 130 through the second coil 112. The second coil 112 may be used to transmit signals to the outside. The wireless power reception device 110 may transmit signals to the outside through the second coil 112. For example, referring to FIG. 3, the wireless power reception device 110 may transmit signals to the accessory device 130 through the second coil 112. For example, referring to FIG. 3, the wireless power reception device 110 may transmit signals to the wireless power transmission device 120 through the second coil 112.

Referring to FIGS. 1C and 1D, according to an embodiment, the accessory device 130 may include a coil 132. As described above, the coil 132 may be used to wirelessly receive power from the outside. According to an embodiment, the coil 132 may be used to receive signals from the outside or transmit signals to the outside. For example, the coil 132 of the accessory device 130 may be used to receive power and transmit and receive signals. For example, referring to FIG. 3, the accessory device 130 may transmit signals to the wireless power reception device 110 through the coil 132. For example, referring to FIG. 3, the accessory device 130 may transmit signals to the wireless power transmission device 120 through the coil 132. For example, referring to FIG. 3, the accessory device 130 may receive signals from the wireless power reception device 110 through the coil 132. For example, referring to FIG. 3, the accessory device 130 may receive signals from the wireless power transmission device 120 through the coil 132.

Referring to FIGS. 1C and 1D, according to an embodiment, the wireless power reception device 110 may include a ferrite 113. The wireless power reception device 110 may include a ferrite 113 on the first coil 111 in the direction toward the inside of the wireless power reception device 110, thereby reducing the effect in which the inside of the wireless power reception device 110 is disturbed by an induced magnetic field. According to an embodiment, the ferrite 113 may be disposed to correspond to the first coil 111 and the second coil 112, as shown in FIG. 1. According to an embodiment, the ferrite 113 may have a portion corresponding to the first coil 111 and a portion corresponding to the second coil 112, which are separate.

Referring to FIGS. 1C and 1D, according to an embodiment, the wireless power transmission device 120 may include a ferrite 123. The wireless power transmission device 120 may include a ferrite 123 on the first coil 121 in the direction toward the inside of the wireless power transmission device 120, thereby increasing the magnitude of power transmitted to the outside through the first coil 121. According to an embodiment, the ferrite 123 may be arranged to correspond to the first coil 121 and the second coil 122, as shown in FIG. 1. According to an embodiment, the ferrite 123 may have a portion corresponding to the first coil 121 and a portion corresponding to the second coil 122, which are separate.

FIGS. 4A and 4B are diagrams illustrating an arrangement of coils of a wireless power reception device according to an embodiment.

FIG. 4A is a diagram illustrating the state in which the wireless power reception device 110 is mounted on the wireless power transmission device 120 so that the user may view the front surface 410 of the wireless power reception device 110. B is a diagram illustrating a front surface 410, a rear surface 420, and a side surface 430 of the wireless power reception device 110.

According to an embodiment, the wireless power reception device 110 (e.g., a housing 400 of the wireless power reception device 110) may include a front surface 410, a rear surface 420, and a side surface 430. The front surface 410 of the wireless power reception device 110 may face in a first direction. For example, a display 440 of the wireless power reception device 110 may be visible through the front surface 410 of the wireless power reception device 110. The rear surface 420 of the wireless power reception device 110 may face in a second direction opposite the first direction. The side surface 430 of the wireless power reception device 110 may be a surface surrounding the space between the front surface 410 and the rear surface 420. According to an embodiment, the side surface 430 of the wireless power reception device 110 may include a first side surface 431 (e.g., a lower side surface), a second side surface 432 (e.g., a left side surface), a third side surface 433 (e.g., an upper side surface), and a fourth side surface 434 (e.g., a right side surface). For example, in the state where the wireless power reception device 110 is mounted on the wireless power transmission device 120, the first side surface 431 (e.g., the lower side surface) among the side surfaces (e.g., 431, 432, 433, and 434) of the wireless power reception device 110 may face the wireless power transmission device 120. The widths of the side surfaces (e.g., 431, 432, 433, and 434) of the wireless power reception device 110 may be smaller than the width and height of the front surface 410 or the rear surface 420. For example, among the width 420a and height 420b of the rear surface 420 of the wireless power reception device 110 and the width 431a and height 431b of the first side surface 431 (e.g., the lower side surface), the width 431a of the first side surface 431 (e.g., the lower side surface) may be the smallest.

Hereinafter, an embodiment in which a coil is disposed on the first side surface 431 (e.g., the lower side surface) will be described. However, those skilled in the art will understand that the case where a coil is disposed on the second side surface 432 (e.g., the left side surface), the third side surface 433 (e.g., the upper side surface), and/or the fourth side surface 434 (e.g., the right side surface) is also similar to the case where a coil is disposed on the first side surface 431 (e.g., the lower side surface).

According to an embodiment, the first coil 111 of the wireless power reception device 110 may be disposed on the first side surface 431 (e.g., the lower side surface). Disposing a specific coil (e.g., the first coil 111) on a specific surface (e.g., the first side surface 431) may include disposing the coil in a region substantially parallel to the surface. Disposing a specific coil in a region substantially parallel to a specific surface may include disposing the coil on the surface. For example, at least a portion (or the entirety) of the first coil 111 may be disposed on the first side surface 431 (e.g., the lower side surface) (e.g., a region substantially parallel to the first side surface 431).

According to an embodiment, the coil (e.g., the first coil 111) may be implemented as a PCB. For example, a printed circuit board (PCB) on which a specific coil is disposed may be disposed on a specific side or in a region substantially parallel to the specific surface. The implementation of the PCB is not limited, and the PCB may be implemented as a flexible printed circuit board (PCB). According to an embodiment, the coil (e.g., the first coil 111) may be implemented using a plating method. For example, a specific coil may be plated on a specific surface, or a plate on which a specific coil is plated may be disposed in a region substantially parallel to the specific face (e.g., a parallel region).

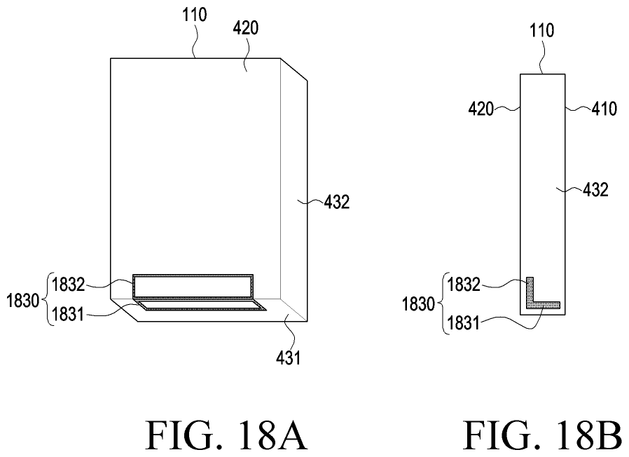

A “parallel region” may refer, for example, to a region substantially parallel to a specific surface. According to an embodiment, the first coil 111 of the wireless power reception device 110 may be disposed in a region including a parallel region of the first side surface 431 (e.g., the lower side surface). For example, at least a portion (or the entirety) of the first coil 111 of the wireless power reception device 110 may be disposed in a parallel region of the first side surface 431 (e.g., the lower side surface). For example, at least a portion of the first coil 111 may be disposed in a region that is not parallel to the first side surface 431 (e.g., the lower side surface). An embodiment in which at least a portion of the first coil 111 is disposed in a region that is not parallel to the first side surface 431 (e.g., the lower side surface) will be described in more detail with reference to FIG. 18.

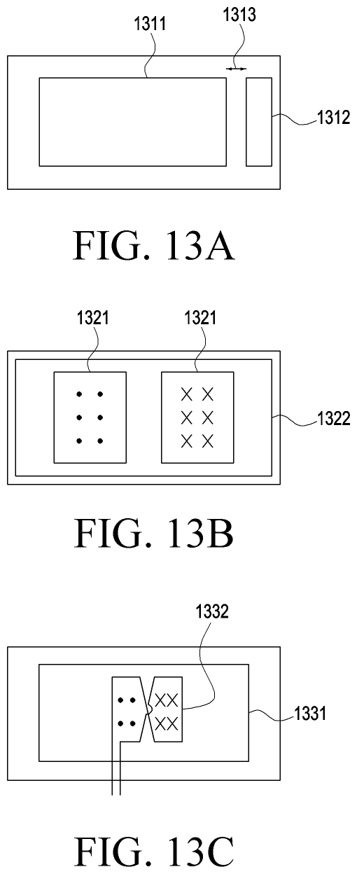

Referring to FIG. 4B and FIGS. 1A, 1B, 1C and 1D, an embodiment in which at least a portion (or the entirety) of the first coil 111 of the wireless power reception device 110 is disposed in the region parallel to the first side surface 431 (e.g., the lower side surface) may be described. According to an embodiment, the first coil 111 (e.g., a coil for transmitting and receiving power) of the wireless power reception device 110 may be disposed in the parallel region of the first side surface 431 (e.g., the lower side surface). According to an embodiment, the wireless power reception device 110 may include a coil (e.g., a coil for transmitting and receiving power) disposed on the rear surface 420, separately from the first coil 111. According to an embodiment, the second coil 112 (e.g., a coil for transmitting and receiving signals) of the wireless power reception device 110 may be disposed in the parallel region of the first side surface 431 (e.g., the lower side surface). The arrangement of the first coil 111 and second coil 112 will be described in greater detail below with reference to FIGS. 13A, 13B and 13C. According to an embodiment, the wireless power reception device 110 may include magnetic members (e.g., 491 and 492) (e.g., magnets) disposed on the first side surface 431 (e.g., the parallel region of the first side surface 431). The magnetic members (e.g., 491 and 492) of the wireless power reception device 110 may be used to coupling (or contact) of the wireless power reception device 110 and the accessory device 130. The number and locations of magnetic members (e.g., 491 and 492) of the wireless power reception device 110 are not limited.

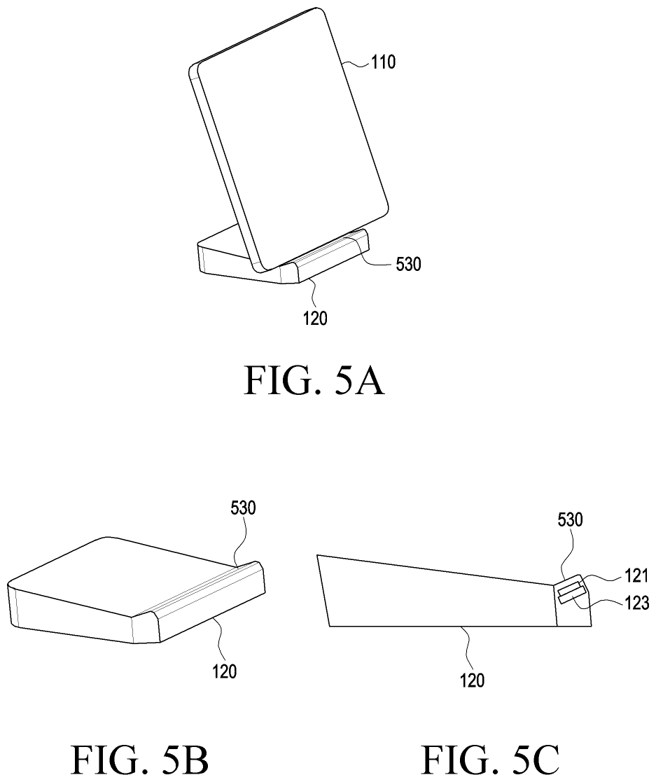

FIGS. 5A, 5B and 5C are diagrams illustrating various arrangements of coils of a wireless power transmission device according to an embodiment.

FIG. 5A is a perspective view illustrating the state in which the wireless power reception device 110 is mounted on the wireless power transmission device 120 so that the user may view the front surface (e.g., 410 in FIG. 4) of the wireless power reception device 110. FIG. 5B is a perspective view of the wireless power transmission device 120. FIG. 5C is a diagram illustrating a side view (e.g., side projection view) of the wireless power transmission device 120.

Referring to FIGS. 5A, 5B and 5C, the wireless power transmission device 120 may include a seating part 530. The wireless power reception device 110 (e.g., the first side surface 431 (e.g., the lower side surface) of the wireless power reception device 110) may be mounted on the seating part 530 of the wireless power transmission device 120.

According to an embodiment, referring to FIG. 5C, the first coil 121 (e.g., a coil for transmitting and receiving power) of the wireless power transmission device 120 may be disposed in the seating part 530 (e.g., inside the seating part 530). For example, the first coil 121 of the wireless power transmission device 120 may be disposed in a parallel region of the seating part 530. According to an embodiment, the second coil 122 (e.g., a coil for transmitting and receiving signals) of the wireless power transmission device 120 may be disposed in the seating part 530 (e.g., inside the seating part 530). For example, the second coil 122 of the wireless power transmission device 120 may be disposed in a parallel region of the seating part 530.

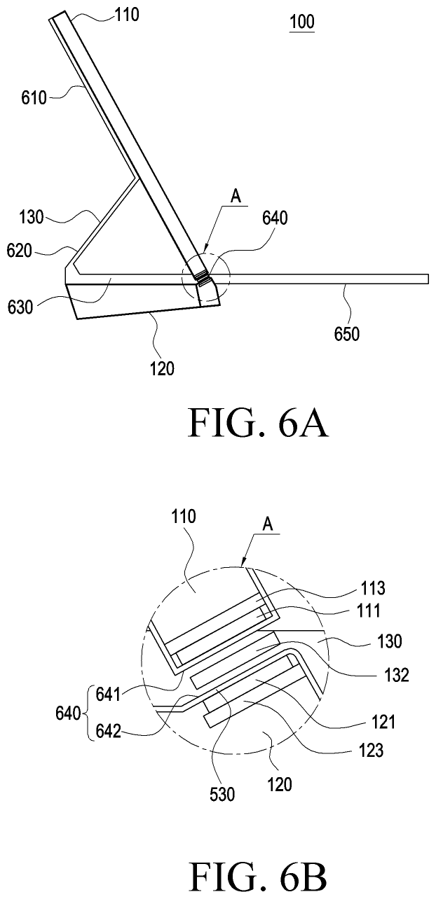

FIGS. 6A and 6B are diagrams illustrating an accessory device according to an embodiment.

FIG. 6A is a diagram illustrating the configuration of the accessory device 130. According to an embodiment, the accessory device 130 may include a first portion 610 (e.g., a cover part), a second portion 620 (e.g., a connection part), a third portion 630, and a fourth portion 640 (e.g., a seating part), and a fifth portion 650. The first portion 610 (e.g., the cover part) of the accessory device 130 may be a portion that covers the rear surface 420 (e.g., at least a portion of the rear surface 420) of the wireless power reception device 110. The fourth portion 640 (e.g., the seating part) of the accessory device 130 may be a portion on which the first side surface 431 (e.g., the lower side surface) of the wireless power reception device 110 is mounted. The third portion 630, the fourth portion 640 (e.g., the seating part), and the fifth portion 650 of the accessory device 130 may form one surface. For example, the third portion 630, the fourth portion 640 (e.g., the seating part), and the fifth portion 650 may form a flat surface, and the fourth portion 640 (e.g., the seating part) may be formed at a designated angle in order for the wireless power reception device 110 to be mounted thereon. According to an embodiment, an input module (e.g., a keyboard) may be disposed in the fifth portion 650 of the accessory device 130. The second portion 620 (e.g., the connection part) of the accessory device 130 may be a portion for connecting the first portion 610 (e.g., the cover part) and the third portion 630. For example, the housing of the accessory device 130 may be folded at the boundary between the first portion 610 (e.g., the cover part) and the second portion 620 (e.g., the connection part), and the housing of the accessory device 130 may be folded at the boundary between the second portion 620 (e.g., the connection part) and the third portion 630. The third portion 630 and the fourth portion 640 (e.g., the seating part) of the accessory device 130 may be mounted on the wireless power transmission device 120.

FIG. 6B is an enlarged projection view of a portion A in FIG. 6A.

FIG. 6B is a diagram illustrating the arrangement of the fourth portion 640 (e.g., a seating part) and the coil 132 of the accessory device 130 according to an embodiment. The fourth portion 640 (e.g., a seating part) of the accessory device 130 may include a first surface 641 on which the wireless power reception device 110 is mounted and facing in a first direction, and a second surface 642 facing in a second direction opposite the first direction and mounted on the seating part 530 of the wireless power transmission device 120. According to an embodiment, the coil 132 (e.g., a coil for receiving power and transmitting and receiving signals) of the accessory device 130 may be disposed inside the fourth portion 640 (e.g., the seating part). For example, the coil 132 may be disposed in a region substantially parallel to the first surface 641 and the second surface 642. Referring to FIGS. 1A, 1B, 1C and 1D, in the state in which the wireless power reception device 110 is mounted on the accessory device 130, the position of the coil 132 (e.g., a coil for receiving power and transmitting and receiving signals) of the accessory device 130 may correspond to the position of the second coil 112 (e.g., a coil for transmitting power and transmit and receiving signals) of the wireless power reception device 110. Referring to FIGS. 1A, 1B, 1C and 1D, in the state in which the accessory device 130 is mounted on the wireless power transmission device 120, the position of the coil 132 of the accessory device 130 may correspond to the position of the second coil 122 (e.g., a coil for transmitting and receiving signals) of the wireless power transmission device 120. Referring to FIGS. 1A, 1B, 1C and 1D, in a state where the wireless power reception device 110 is mounted on the accessory device 130 and where the accessory device 130 is mounted on the wireless power transmission device 120, the position of the first coil 111 (e.g., a coil for transmitting and receiving power) of the wireless power reception device 110 may correspond to the position of the first coil 112 (e.g., a coil for transmitting and receiving power) of the wireless power transmission device 120.

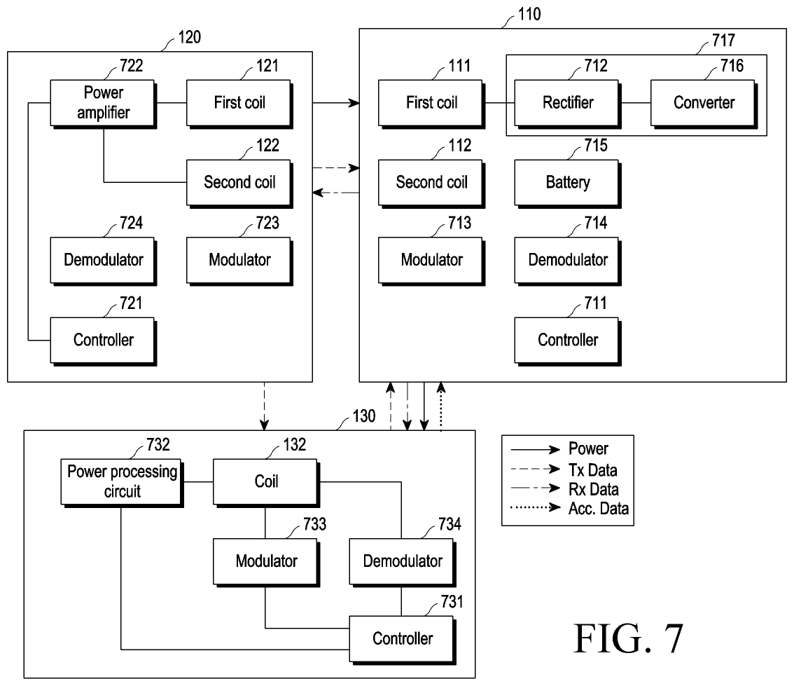

FIG. 7 is a block diagram illustrating example configurations of devices included in a wireless charging system according to an embodiment.

Referring to FIG. 7, according to an embodiment, the wireless power transmission device 120 may include a controller (e.g., including processing and/or control circuitry) 721, a power amplifier 722, a first coil 121, a second coil 122, a modulator 723, and a demodulator 724. According to an embodiment, the wireless power reception device 110 may include a controller (e.g., including processing and/or control circuitry) 711, a first coil 111, a second coil 112, a rectifier 712, a modulator 713, a demodulator 714, and a battery 715. According to an embodiment, the accessory device 130 may include a controller (e.g., including processing and/or control circuitry) 731, a coil 132, a power processing circuit 732, a modulator 733, and a demodulator 734.

According to an embodiment, the controller 721 may include various processing and/or control circuitry and be implemented as one controller or multiple controllers. The implemented form of the controller 721 is not limited, and hereinafter, the operation of the controller 721 will be described, encompassing a single controller and multiple controllers. The controller 711 and the controller 731 may also be implemented as one controller or multiple controllers. Hereinafter, the operation of the controller 711 and the operation of the controller 731 will be described. The controller (e.g., 721, 711, 731) may include various processing circuitry and/or multiple processors and/or various control circuitry. For example, as used herein, including the claims, the term “processor” and/or “controller” may include various processing circuitry, including at least one processor, wherein one or more of at least one processor, individually and/or collectively in a distributed manner, may be configured to perform various functions described herein. As used herein, when “a processor”, “at least one processor”, and “one or more processors” and/or “controllers” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor (or controller) may include a combination of processors (or controllers) performing various of the recited/disclosed functions, e.g., in a distributed manner. At least one processor (or controller) may execute program instructions to achieve or perform various functions.

According to an embodiment, the wireless power transmission device 120 may include a power source. The power source of the wireless power transmission device 120 may provide alternating current power with a frequency of fs. The power source of the wireless power transmission device 120 may include, for example, an oscillator, a DC/DC converter, and/or a power amplifier 722 to provide alternating current power, and the implemented form of the power source of the wireless power transmission device 120 is not limited. For example, the power source (e.g., the power amplifier 722) of the wireless power transmission device 120 may provide alternating current power (e.g., a radio frequency (RF) signal) under the control of the controller 721. The controller 721 may control, for example, the magnitude of alternating current power. The controller 721 may control, for example, the frequency (fs) of alternating current power. The implemented form of the power amplifier 722 is not limited.

According to an embodiment, the wireless power transmission device 120 may include at least one capacitor connected to the first coil 121. The first coil 121 and at least one capacitor may form a resonant circuit. The resonant circuit may have a resonant frequency that depends on the inductance of the first coil 121 and the capacitance of at least one capacitor. The number of capacitors is not limited. The resonant circuit may preferably have a resonant frequency equal to the frequency (fs) of alternating current power provided from the power source (e.g., the power amplifier 722).

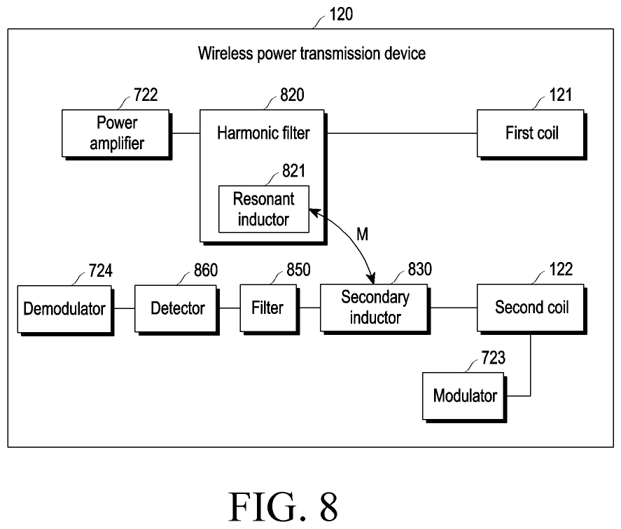

According to an embodiment, the power amplifier 722 of the wireless power transmission device 120 may provide alternating current power to the first coil 121 under the control of the controller 721. Harmonic components of the alternating current power provided from the power amplifier 722 may be transmitted to the second coil 122, which will be described in more detail with reference to FIG. 8. According to an embodiment, the modulator 723 of the wireless power transmission device 120 may be connected to the second coil 122. The modulator 723 of the wireless power transmission device 120 may be configured to provide signals (e.g., data) to the outside through the second coil 122, based on the harmonic component of the alternating current power provided from the power amplifier 722, under the control of the controller 721. For example, the modulator 723 of the wireless power transmission device 120 may include a switch (e.g., a transistor). For example, the modulator 723 of the wireless power transmission device 120 may be implemented as a cut-off switch. According to an embodiment, the demodulator 724 of the wireless power transmission device 120 may be configured to demodulate a signal (e.g., data) identified through the second coil 122. For example, the wireless power transmission device 120 (e.g., the controller 721) may identify a signal (e.g., data) provided from the outside through the second coil 122 using the demodulator 724.

According to an embodiment, the wireless power reception device 110 may include a power processing circuit 717. The power processing circuit 717 of the wireless power reception device 110 may process power received through the first coil 111. For example, the power processing circuit 717 of the wireless power reception device 110 may include a rectifier 712 and/or a DC/DC converter 716. The implemented form of the power processing circuit 717 is not limited. For example, the power processing circuit 717 of the wireless power reception device 110 may supply charging power to the battery 715, based on the power received through the first coil 111, under the control of the controller 711.

According to an embodiment, the modulator 713 of the wireless power reception device 110 may be connected to the second coil 112. The modulator 713 of the wireless power reception device 110 may be configured to provide signals (e.g., data) to the outside through the second coil 112 under the control of the controller 711. For example, the modulator 713 of the wireless power reception device 110 may include a switch (e.g., a transistor). For example, the modulator 713 of the wireless power reception device 110 may be implemented as a bidirectional converter. According to an embodiment, the demodulator 714 of the wireless power reception device 110 may be configured to demodulate signals (e.g., data) identified through the second coil 112. For example, the wireless power transmission device 110 (e.g., the controller 711) may identify signals (e.g., data) provided from the outside through the second coil 112 using the demodulator 714.

According to an embodiment, the modulator 733 of the accessory device 130 may be connected to the coil 132. The modulator 733 of the accessory device 130 may be configured to provide signals (e.g., data) to the outside through the coil 132 under the control of the controller 731. For example, the modulator 733 of the accessory device 130 may include a switch (e.g., a transistor). For example, the modulator 733 of the accessory device 130 may be implemented as a load modulator. According to an embodiment, the demodulator 734 of the accessory device 130 may be configured to demodulate signals (e.g., data) identified through the coil 132. For example, the accessory device 130 (e.g., the controller 731) may identify signals (e.g., data) provided from the outside through the coil 132 using the demodulator 734.

Referring to FIG. 7, the wireless power transmission device 120 may wirelessly transmit power to the wireless power reception device 110 through the first coil 121. The wireless power transmission device 120 may transmit a signal (e.g., Tx data) to the wireless power reception device 110 through the second coil 122. Tx data may include data of the wireless power transmission device 120 in relation to wireless power transmission. The wireless power transmission device 120 may receive a signal (e.g., Rx data) from the wireless power reception device 110 through the second coil 122. Rx data may include data of the wireless power reception device 110 in relation to wireless power transmission. The wireless power transmission device 120 may transmit a signal (e.g., Tx data) to the accessory device 130 through the second coil 122. The wireless power reception device 110 may wirelessly receive power from the wireless power transmission device 120 through the first coil 111. The wireless power reception device 110 may transmit a signal (e.g., Rx data) to the wireless power transmission device 120 through the second coil 112. The wireless power reception device 110 may receive a signal (e.g., Tx data) from the wireless power transmission device 120 through the second coil 112. The wireless power reception device 110 may transmit a signal (e.g., Rx data) to the accessory device 130 through the second coil 112. Rx data may be designated data transmitted from the wireless power reception device 110 to the accessory device 130, and there is no limitation on the type of designated data. The wireless power reception device 110 may receive signals (e.g., Acc. data and/or Tx data) from the accessory device 130 through the second coil 112. Acc. data may include data based on input (e.g., input through a keyboard) identified by the accessory device 130. Acc. data may be data related to wireless power transmission between the wireless power transmission device 120 and the wireless power reception device 110, based on Tx data provided from the accessory device 130 and Tx data received by the accessory device 130 from the wireless power transmission device 120. The wireless power reception device 110 may wirelessly transmit power to the accessory device 130 through the second coil 112. A method of transmitting power from the wireless power reception device 110 to the accessory device 130 will be described in greater detail below. The accessory device 130 may receive a signal (e.g., Tx data) from the wireless power transmission device 120 through the coil 132. The accessory device 130 may transmit signals (e.g., Acc. data and/or Tx data) to the wireless power reception device 110 through the coil 132. The signals (e.g., data) provided from the accessory device 130 to the wireless power reception device 110 may include data related to the accessory device 130 and data related to the wireless power transmission device 120. The signals (e.g., data) provided from the accessory device 130 to the wireless power reception device 110 will be described later. The accessory device 130 may receive a signal (e.g., Rx data) from the wireless power reception device 110 through the coil 132. The accessory device 130 may wirelessly receive power from the wireless power reception device 110 through the coil 132. A method of transmitting power from the wireless power reception device 110 to the accessory device 130 will be described later.

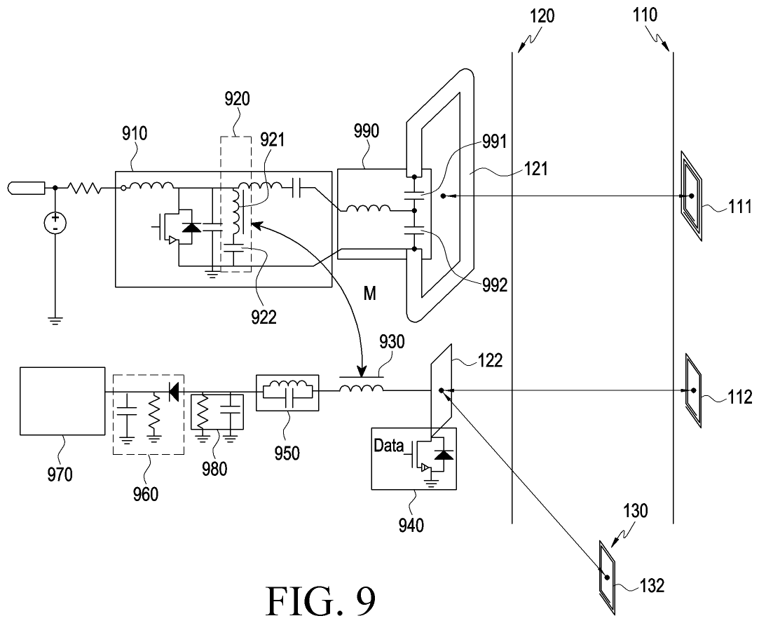

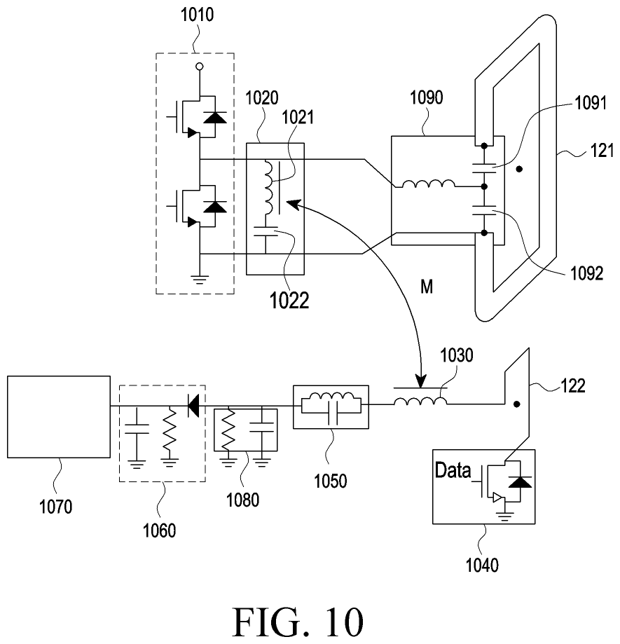

FIG. 8 is a block diagram illustrating an example configuration of a wireless power transmission device according to an embodiment. FIG. 9 is a circuit diagram illustrating an example configuration of a wireless power transmission device according to an embodiment. FIG. 10 is a circuit diagram illustrating an example configuration of a wireless power transmission device according to an embodiment.

Referring to FIGS. 7 and 8, the wireless power transmission device 120 may include a controller 721, a power amplifier 722, a harmonic filter 820, a first coil 121, a secondary inductor 830, a second coil 122, a modulator 723, a filter 850, a detector 860, and demodulator 724.

According to an embodiment, the harmonic filter 820 of the wireless power transmission device 120 may be configured to filter harmonic components of power provided from the power amplifier 722 to the first coil 121. For example, the harmonic filter 820 may include a resonant circuit including a resonant inductor 821 and a resonant capacitor. The resonant inductor 821 of the harmonic filter 820 and the secondary inductor 830 may be magnetically coupled. The number of turns of the secondary inductor 830 may be less than the number of turns of the resonant inductor 821 of the harmonic filter 820. The secondary inductor 830 may receive harmonic components of the power provided from the power amplifier 722 to the first coil 121 through the resonant inductor 821 of the harmonic filter 820. According to an embodiment, the resonant inductor 821 of the harmonic filter 820 and the secondary inductor 830 may form a transformer. For example, an iron core may be disposed at the center of the resonant inductor 821 of the harmonic filter 820 and the secondary inductor 830. The secondary inductor 830 may be connected to the second coil 122 (e.g., a coil for transmitting and receiving signals). The second coil 122 may receive harmonic components of the power provided from the power amplifier 722 to the first coil 121 through the secondary inductor 830. According to an embodiment, the harmonic component provided to the second coil 122 may be a secondary harmonic wave. For example, the resonant inductor 821 of the harmonic filter 820 and the resonant capacitor may form a resonant circuit that filters the secondary harmonic wave of the power provided from the power amplifier 722 to the first coil 121. For example, based on the power provided from the power amplifier 722, the frequency of the power provided to the second coil 122 may be twice the frequency of the power provided to the first coil 121. However, this is only an example, and the harmonic component provided to the second coil 122 may be determined depending on the order of the harmonic filter 820 (e.g., n of the nth harmonic filter).

According to an embodiment, the filter 850 of the wireless power transmission device 120 may be configured to filter a signal identified through the second coil 122 from the outside (e.g., the wireless power reception device 110). For example, although the filter 850 of the wireless power transmission device 120 may be implemented as an electromagnetic compatibility (EMC) filter that filters frequency components (e.g., a primary frequency component and/or a tertiary frequency component) of a signal identified through the second coil 122, there is no limitation on the implemented form of the filter 850.

According to an embodiment, the detector 860 of the wireless power transmission device 120 may be configured to detect the envelope of a signal (e.g., a modulated signal) identified from the outside (e.g., the wireless power reception device 110) through the second coil 122. According to an embodiment, the wireless power transmission device 120 may demodulate a received signal (e.g., a modulated signal) using the detector 860 and the demodulator 724.

FIG. 9 is a circuit diagram illustrating an example configuration corresponding to FIG. 8 according to various embodiments.

Referring to FIG. 9, according to an embodiment, the wireless power transmission device 120 may include a power amplifier 910 (e.g., the power amplifier 722 in FIGS. 7 and 8). The power amplifier 910 in FIG. 9 may be, for example, a power amplifier in the structure of class-EF2. The wireless power transmission device 120 may include a matching network 990 connected to the first coil 121. For example, the matching network 990 may include a series capacitor 991 connected in series to the first coil 121 and/or a parallel capacitor 992 connected in parallel to the first coil 121. The first coil 121 may form a resonant circuit together with the series capacitor 991 and/or the parallel capacitor 992. The wireless power transmission device 120 may include a secondary harmonic filter 920 (e.g., the harmonic filter 820 in FIG. 8) that filters the secondary harmonic component of the alternating current power provided from the power amplifier 910 to the first coil 121. For example, the secondary harmonic filter 920 may include a resonant inductor 921 (e.g., the resonant inductor 821 in FIG. 8) and a resonant capacitor 922 that form a resonant circuit. The wireless power transmission device 120 may include a secondary inductor 930 (e.g., the secondary inductor 830 in FIG. 8) that is magnetically coupled to the resonant inductor 921 of the secondary harmonic filter 920. The secondary inductor 930 may be connected to the second coil 122, and the second coil 122 may be provided with the secondary harmonic component of the alternating current power provided from the power amplifier 910 to the first coil 121 through the secondary inductor 930. The wireless power transmission device 120 may include a filter 950 (e.g., the filter 850 in FIG. 8), a matching network 980, a detector 960 (e.g., the detector 860 in FIG. 8), a demodulator 970 (e.g., the demodulator 724 in FIGS. 7 and 8), and a modulator 940 (e.g., the modulator 723 in FIGS. 7 and 8).

FIG. 10 is a circuit diagram illustrating an example configuration corresponding to FIG. 8 according to various embodiments.

Referring to FIG. 10, according to an embodiment, the wireless power transmission device 120 may include a power amplifier 1010 (e.g., the power amplifier 722 in FIGS. 7 and 8). The power amplifier 1010 in FIG. 10 may be, for example, a power amplifier in a half-bridge structure. Those skilled in the art may understand that the power amplifier (e.g., the power amplifier 722 in FIGS. 7 and 8) of the wireless power transmission device 120 may be implemented in a full-bridge structure. The wireless power transmission device 120 may include a matching network 1090 connected to the first coil 121. For example, the matching network 1090 may include a series capacitor 1091 connected in series to the first coil 121 and/or a parallel capacitor 1092 connected in parallel to the first coil 121, and the series capacitor and the parallel capacitor have been described above in FIG. 9. The wireless power transmission device 120 may include an nth-order harmonic filter 1020 (e.g., the harmonic filter 820 in FIG. 8) that filters the harmonic components of the alternating current power provided from the power amplifier 1010 to the first coil 121. For example, the harmonic filter 1020 may include a resonant inductor 1021 (e.g., the resonant inductor 821 in FIG. 8) and a resonant capacitor 1022 that form a resonant circuit. The wireless power transmission device 120 may include a secondary inductor 1030 (e.g., the secondary inductor 830 in FIG. 8) that is magnetically coupled to the resonant inductor 1021 of the harmonic filter 1020. The secondary inductor 1030 may be connected to the second coil 122, and the second coil 122 may be provided with an nth-order harmonic component (e.g., tertiary, fifth-order, or seventh-order harmonic component) of the alternating current power provided from the power amplifier 1010 to the first coil 121 through the secondary inductor 1030. The wireless power transmission device 120 may include a filter 1050 (e.g., the filter 850 in FIG. 8), a matching network 1080, a detector 1060 (e.g., the detector 860 in FIG. 8), a demodulator 1070 (e.g., the demodulator 724 in FIGS. 7 and 8), and a modulator 1040 (e.g., the modulator 723 in FIGS. 7 and 8).

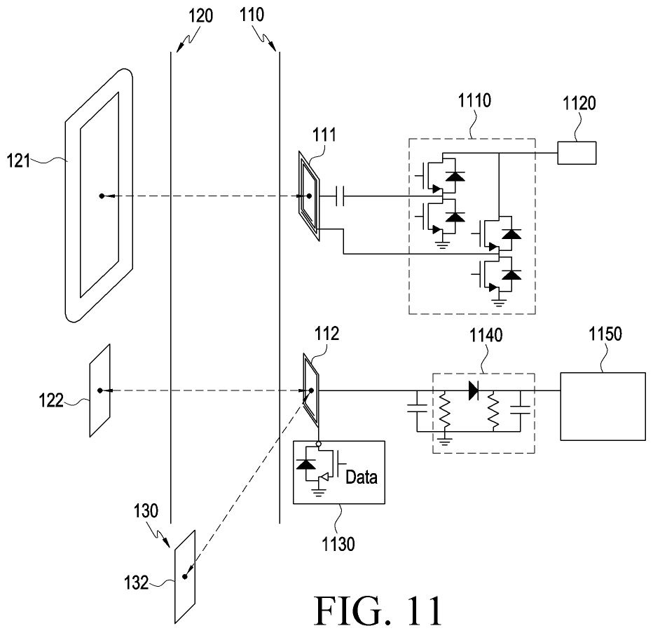

FIG. 11 is a circuit diagram illustrating an example configuration of a wireless power reception device according to an embodiment.

FIG. 11 is an example circuit diagram illustrating an example configuration corresponding to the wireless power reception device 110 in FIG. 7 according to an embodiment.

Referring to FIG. 11, according to an embodiment, the wireless power reception device 110 may include a rectifier 1110 (e.g., the rectifier 712 in FIG. 7) and a converter 1120 (e.g., a linear regulator (LDO)). For example, the rectifier 1110 may be implemented in a full-bridge structure, but there is no limitation on the implemented form of the rectifier (e.g., the rectifier 712 in FIG. 7). The wireless power reception device 110 may provide charging power to a battery (e.g., the battery 715 in FIG. 7) through a power processing circuit including the rectifier 1110 and the converter 1120. The wireless power reception device 110 may include a modulator 1130 (e.g., the modulator 713 in FIG. 7) connected to the second coil 112. The wireless power reception device 110 may include a detector 1140 that detects the envelope of a signal (e.g., a modulated signal) received through the second coil 112. The wireless power reception device 110 may demodulate a signal (e.g., a modulated signal) received through the second coil 112 using a demodulator 1150 (e.g., the demodulator 714 in FIG. 7).

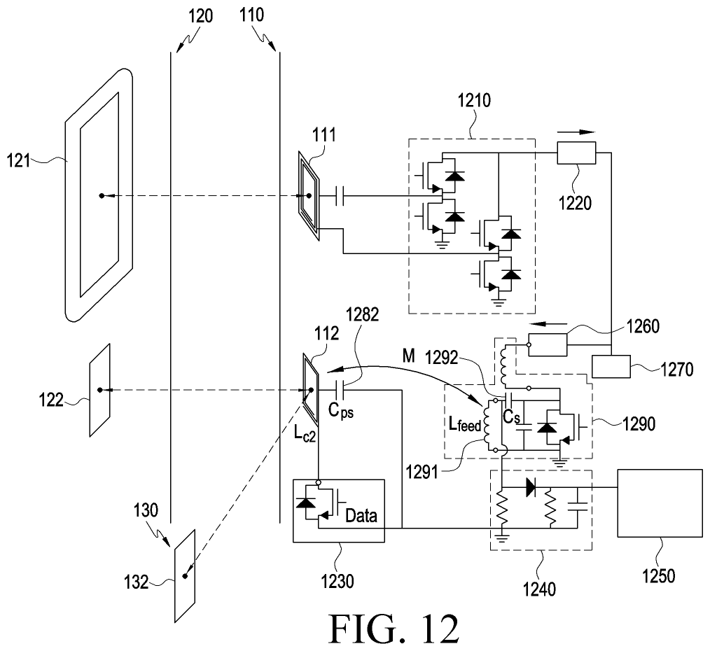

FIG. 12 is a circuit diagram illustrating an example configuration of a wireless power reception device according to an embodiment.

FIG. 12 is an example circuit diagram illustrating an example configuration corresponding to the wireless power reception device 110 in FIG. 7 according to an embodiment.

Referring to FIG. 12, according to an embodiment, the wireless power reception device 110 may include a rectifier 1210 (e.g., the rectifier 712 in FIG. 7) and a converter 1220 (e.g., a linear regulator (LDO)). The wireless power reception device 110 may supply charging power to a battery 1270 (e.g., the battery 715 in FIG. 7) through a power processing circuit including the rectifier 1210 and the converter 1220 (e.g., a linear regulator (LDO)). According to an embodiment, the wireless power reception device 110 may include a modulator 1230 (e.g., 713 in FIG. 7), a detector 1240, and a demodulator 1250 (e.g., the demodulator 714 in FIG. 7). According to an embodiment, referring to FIG. 12, the wireless power reception device 110 may include a power amplifier 1290. According to an embodiment, the wireless power reception device 110 may include a converter 1260 (e.g., a linear regulator (LDO)) configured to provide power to the power amplifier 1290. For example, the wireless power reception device 110, based on the power provided from the battery 1270 or power provided from a power processing circuit (e.g., a power processing circuit including the rectifier 1210 and the converter 1220), may supply power to the power amplifier 1290 through the converter 1260 under the control of the controller 711. The power amplifier 1290 may output alternating current power, based on the power provided through the converter 1260. According to an embodiment, the wireless power reception device 110, based on the power provided from the power amplifier 1290, may wirelessly transmit power to the outside (e.g., the accessory device 130) through the second coil 112 under the control of the controller 711. For example, a feed inductor 1291 of the power amplifier 1290 and the second coil 112 may be magnetically coupled. The second coil 112 may receive power output from the power amplifier 1290 through the feed inductor 1291. The form of the power amplifier 1290 of the wireless power reception device 110 is an example, and there is no limitation on the implemented form of the power amplifier included in the wireless power reception device 110.

According to an embodiment, the wireless power reception device 110 may include a resonant capacitor 1282 connected to the second coil 112. The capacitance (e.g., Cps) of the resonant capacitor 1282 connected to the second coil 112 may be determined by the inductance (e.g., L_{c2}) of the second coil 112.

$${c}_{ps} = \frac{1}{{w}^{2} {L}_{c 2}} \qquad [ Equation 1 ]$$

According to an embodiment, the wireless power reception device 110 may include a resonant capacitor 1292 connected to the feed inductor 1291. The capacitance (e.g., Cₛ) of the resonant capacitor 1292 connected to the feed inductor 1291 may be determined by the inductance (e.g., L_{feed}) of the feed inductor 1291.

$${c}_{s} = \frac{1}{{w}^{2} {L}_{feed}} \qquad [ Equation 2 ]$$

FIGS. 13A, 13B and 13C are diagrams illustrating example arrangements of coils according to an embodiment.

The arrangement of coils in FIG. 13 may be the arrangement of the first coil 121 and the second coil 122 of the wireless power transmission device 120. The arrangement of coils in FIG. 13 may be the arrangement of the first coil 111 and the second coil 112 of the wireless power reception device 110.

FIG. 13A shows an embodiment in which a coil for transmitting and receiving power and a coil for transmitting and receiving signals are disposed to be spaced apart by a specified distance. Referring to FIG. 13A, according to an embodiment, a first coil 1311 (e.g., the first coil 121 or the first coil 111) and a second coil 1312 (e.g., the second coil 122 or the second coil 112) may be disposed to be spaced apart by a specified distance 1313. For example, the specified distance 1313 may be determined such that interference between the magnetic field by the first coil 1311 and the magnetic field by the second coil 1312 is reduced.

FIG. 13B shows an embodiment in which a coil for transmitting and receiving power is disposed in an inner area of a coil for transmitting and receiving signals. Referring to FIG. 13B, according to an embodiment, a first coil 1321 (e.g., the first coil 121 or the first coil 111) may be disposed in the inner area of a second coil 1322 (e.g., the second coil 122 or the second coil 112). For example, as shown in FIG. 13B, a first winding direction of at least a portion of the first coil 1321 (e.g., the first coil 121 or the first coil 111) and a second winding direction of at least another portion of the first coil 1321 (e.g., the first coil 121 or the first coil 111) may be different. Since the first winding direction and the second winding direction are different, the magnetic field may be canceled out, thereby reducing the interference between the magnetic field by the first coil 1321 and the magnetic field by the second coil 1322.

FIG. 13C shows an embodiment in which a coil for transmitting and receiving signals is disposed in an inner area of a coil for transmitting and receiving power. Referring to FIG. 13C, according to an embodiment, a second coil 1332 (e.g., the second coil 122 or the second coil 112) may be disposed in the inner area of the first coil 1331 (e.g., the first coil 121 or the first coil 111). For example, as shown in FIG. 13C, the second coil 1332 (e.g., the second coil 122 or the second coil 112) may be arranged in an “8” shape so that a first winding direction of at least a portion of the second coil 1332 (e.g., the second coil 122 or the second coil 112) and a second winding direction of at least another portion of the second coil 1332 (e.g., the second coil 122 or the second coil 112) may be different. Since the first winding direction and the second winding direction are different, the magnetic field may be canceled out, thereby reducing the interference between the magnetic field by the first coil 1321 and the magnetic field by the second coil 1322.

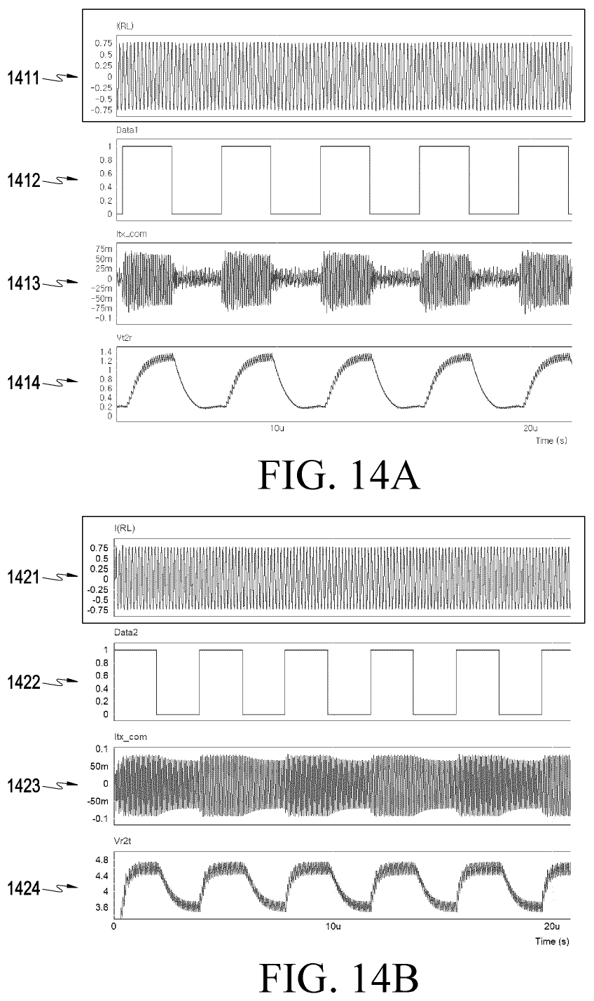

FIGS. 14A and 14B are diagrams illustrating power transmission between a wireless power transmission device and a wireless power reception device, and communication waveforms thereof according to an embodiment.

The first graph 1411 in FIG. 14A is a graph of a current flowing through the first coil 121 of the wireless power transmission device 120 while the wireless power transmission device 120 and the wireless power reception device 110 are communicating with each other. The second graph 1412 in FIG. 14A is a graph of a signal transmitted from the wireless power transmission device 120 to the wireless power reception device 110 through the second coil 122. The third graph 1413 in FIG. 14A is a graph of a current flowing through the second coil 112 of the wireless power reception device 110, based on the signal transmitted to the wireless power reception device 110. The fourth graph 1414 in FIG. 14A is a graph of a signal demodulated by the demodulator 714 in the wireless power reception device 110. The fifth graph 1421 in FIG. 14B is a graph of a current flowing through the first coil 121 of the wireless power transmission device 120 while the wireless power transmission device 120 and the wireless power reception device 110 are communicating with each other. The sixth graph 1422 in FIG. 14B is a graph of a signal transmitted from the wireless power reception device 110 to the wireless power transmission device 120 through the second coil 112. The seventh graph 1423 in FIG. 14B is a graph of a current flowing through the second coil 122 of the wireless power transmission device 120, based on the signal transmitted to the wireless power transmission device 120. The eighth graph 1424 in FIG. 14B is a graph of a signal demodulated by the demodulator 724 in the wireless power transmission device 110.

Referring to FIGS. 14A and 14B, it can be identified that a change in current flowing through the first coil 121 of the wireless power transmission device 120 is equal to or less than a reference value while a signal (e.g., data) is transmitted from the wireless power transmission device 120 to the wireless power reception device 110 through the second coil 122 or while a signal (e.g., data) is transmitted from the wireless power reception device 110 to the wireless power transmission device 120 through the second coil 112. Therefore, power transmission efficiency is hardly affected by communication.

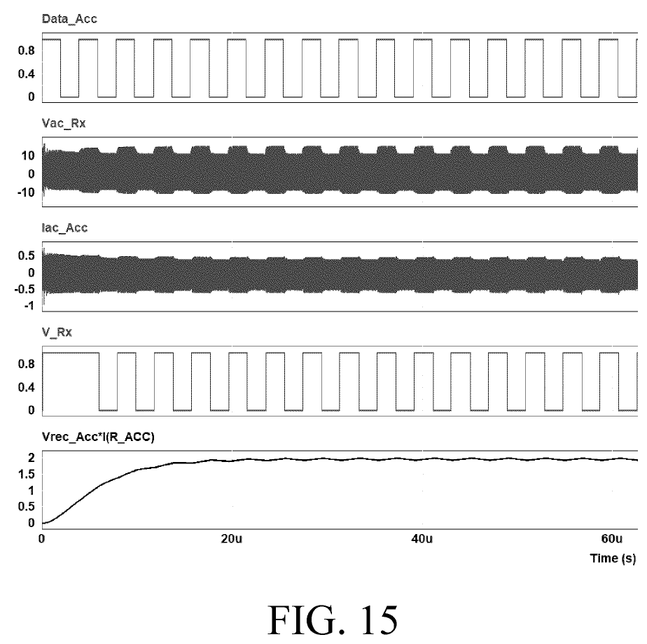

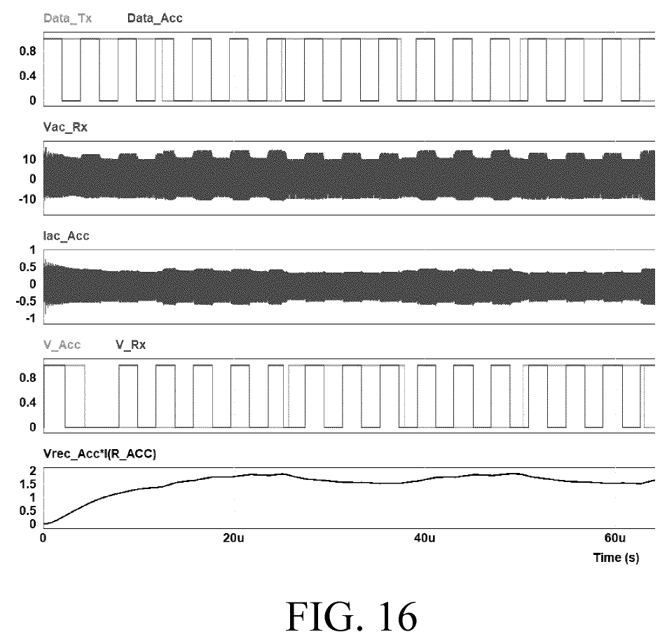

FIG. 15 is a diagram illustrating power transmission between an accessory device and a wireless power reception device, and communication waveforms according to an embodiment. FIG. 16 is a diagram illustrating communication waveforms of communication through an accessory device according to an embodiment.

FIG. 15 is a graph showing that a signal (e.g., data of 256 kbps) is transmitted from the accessory device 130 to the wireless power reception device 110 through load modulation. Referring to FIG. 15, it can be identified that power is transmitted from the wireless power reception device 110 to the accessory device 130 while a signal (e.g., data of 256 kbps) is transmitted from the accessory device 130 to the wireless power reception device 110.

FIG. 16 is a graph showing that a signal (e.g., data of 40 kbps) is transmitted from the accessory device 130 to the wireless power reception device 110, based on the signal transmitted from the wireless power transmission device 120 to the accessory device 130. For example, it may be identified that Data_Tx and Data_Acc operate at different frequencies in FIG. 16. Data_Tx indicates that data related to power transmission is transmitted from the accessory device 130 to the wireless power reception device 110. Data_Acc indicates that data related to the accessory device 130 (e.g., data corresponding to keyboard input) is transmitted to the wireless power reception device 110.

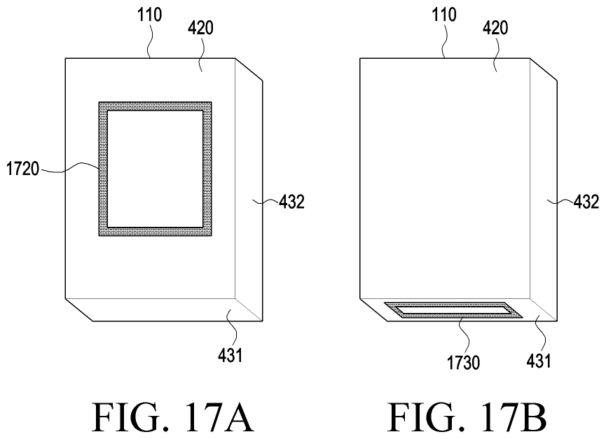

FIGS. 17A and 17B are perspective views illustrating an arrangement of coils of a wireless power reception device according to an embodiment.

The area of a coil (e.g., the number of turns) and the frequency of power will be described in relation to the amount of power transmitted and received with reference to FIG. 17. The larger the area of the coil, the greater the amount of power transmitted and received. The higher the frequency of power, the larger the amount of power transmitted and received. As the area of a coil for transmitting and receiving power increases, for example, as the number of turns of the coil for transmitting and receiving power increase, the amount of power transmitted and received through the coil may increase. In order to transmit and receive power through a small-area coil, for example, a coil with a small number of turns, the frequency of power may need to be increased, compared to when transmitting power through a large-area coil, for example, a coil with a large number of turns. For example, in the case where a first amount of power having a first frequency is transmitted and received through the first coil having a first area, in order to transmit and receive a first amount of power having a second frequency through the second coil having a second area smaller than the first area, the second frequency may need to be set higher than the first frequency. In order to transmit and receive a specified amount of power while reducing the area of the coil, the frequency of the power may be increased. In order to transmit and receive a specified amount of power while lowering the frequency of power, the area of the coil may be increased.

FIG. 17A shows an embodiment in which a first power transmission/reception coil 1720 is disposed on the rear surface 420 of the wireless power reception device 110. FIG. 17B shows an embodiment in which a second power transmission/reception coil 1730 (e.g., the first coil 111 of the wireless power reception device 110) is disposed on the side surface (e.g., the lower side surface 431) of the wireless power reception device 110. Since the area of the rear surface 420 of the wireless power reception device 110 is greater than the area of the side surface (e.g., 431 and 432), a first power transmission/reception coil 1720 having a larger area than the side surface (e.g., 431 and 432) may be disposed on the rear surface 420. Since the area of the lower side surface 431 of the wireless power reception device 110 is less than the area of the rear surface 420, a second power transmission/reception coil 1730 having a smaller area than the rear surface 420 may be disposed on the lower side surface 431. Since the area (e.g., the number of turns) of the second power transmission/reception coil 1730 is smaller than the area (e.g., the number of turns) of the first power transmission/reception coil 1720, in order to transmit and receive the same amount of power, the second frequency of the alternating current power applied to the second power transmission/reception coil 1730 may be set higher than the first frequency of the alternating current power applied to the first power transmission/reception coil 1720. By disposing the second power transmission/reception coil 1730 on the lower side surface 431 of the wireless power reception device 110 and by increasing the frequency of the alternating current power provided from the power amplifier (e.g., 722 in FIG. 7) to the second power transmission/reception coil 1730, a specified amount of power may be transmitted and received through the second power transmission and reception coil 1730. By increasing the frequency of the alternating current power provided to the second power transmission/reception coil 1730, the area (e.g., the number of turns) of the second power transmission/reception coil 1730 for transmitting and receiving a specified amount of power may be reduced.

FIGS. 18A and 18B include a perspective view and diagram illustrating an arrangement of coils of a wireless power reception device according to an embodiment.

A is a perspective projection view of the wireless power reception device 110. FIG. 18B is a left side projection view of the wireless power reception device 110.

Referring to FIGS. 18A and 18B, according to an embodiment, the wireless power reception device 110 may include a power transmission/reception coil 1830 (e.g., the first coil 111). For example, the power transmission/reception coil 1830 may include a first portion 1831 disposed to be substantially parallel to the lower side surface 341, and a second portion 1832 disposed to be substantially parallel to the rear surface 420 (e.g., a partial region in the lower portion of the rear surface 420). For example, the area of the partial region in the lower portion of the rear surface 420 where the second portion 1831 of the power transmission/reception coil 1830 is disposed in FIG. 18 may be smaller than the area of the region where the first power transmission/reception coil 1720 is disposed on the rear surface 420 in FIGS. 17AS. 18A and 18B, compared to FIG. 17A, power may be transmitted and received through a coil having a relatively small area.

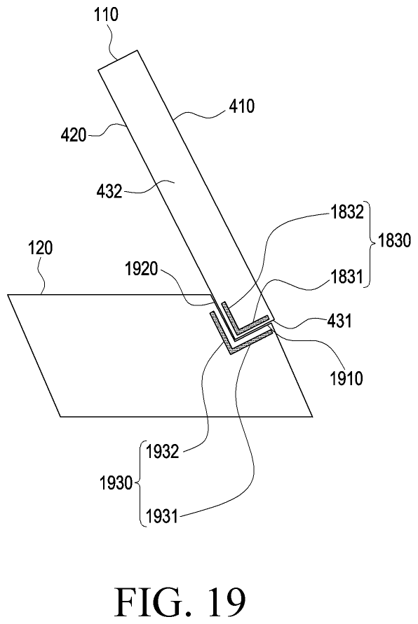

According to an embodiment, the wireless power reception device 110 may wirelessly transmit and receive power through the power transmission/reception coil 1830 (e.g., the first coil 111). For example, the wireless power reception device 110 may wirelessly receive power from the wireless power transmission device 120 through the power transmission/reception coil 1830 (e.g., the first coil 111). The coils of the wireless power transmission device 120 may be disposed to correspond to the arrangement of the coils of the wireless power reception device 110, which will be described in greater detail below with reference to FIG. 19.

FIG. 19 is a diagram illustrating an example arrangement of coils of a wireless power transmission device according to an embodiment.

FIG. 19 is a side view showing that the wireless power reception device 110 is disposed on the wireless power transmission device 120. According to an embodiment, the wireless power reception device 110, like FIGS. 18A and 18B, may include a power transmission/reception coil 1830 (e.g., the first coil 111) including a first portion 1831 disposed substantially parallel to the lower side surface 431 and a second portion 1832 disposed substantially parallel to the rear surface 420 (e.g., a partial region in the lower portion of the rear surface 420). According to an embodiment, the wireless power transmission device 120 may include a first seating part 1910 on which the lower side surface 431 of the wireless power reception device 110 is mounted and a second seating part 1920 on which a partial region of the rear surface 420 of the wireless power reception device 110 is mounted.

Referring to FIG. 19, according to an embodiment, the wireless power transmission device 120 may include a power transmission/reception coil 1930 (e.g., the first coil 121 of the wireless power transmission device 120). For example, the power transmission/reception coil 1930 (e.g., the first coil 121 of the wireless power transmission device 120) may include a first portion 1931 disposed substantially parallel to the first seating part 1910 and a second portion 1932 disposed substantially parallel to the second seating part 1920. The power transmission/reception coil 1930 of the wireless power transmission device 120 (e.g., the first coil 121 of the wireless power transmission device 120) may be disposed to correspond to the arrangement of the power transmission/reception coil 1830 (e.g., the first coil 111) of the wireless power reception device 110.

According to an embodiment, the wireless power transmission device 120 may wirelessly transmit and receive power through the power transmission/reception coil 1930 (e.g., the first coil 121 of the wireless power transmission device 120). For example, the wireless power transmission device 120 may wirelessly transmit power to the wireless power reception device 110 through the power transmission/reception coil 1930 (e.g., the first coil 121 of the wireless power transmission device 120).

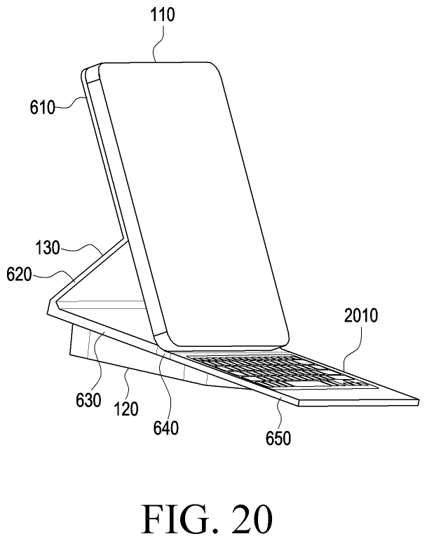

FIG. 20 is a perspective view illustrating a keyboard included in an accessory device according to an embodiment.

Referring to FIG. 20, according to an embodiment, the accessory device 130 may include an input module (e.g., a keyboard 2010) disposed in the fifth portion 650.

According to an embodiment, the accessory device 130 may transmit signals (e.g., data) to the wireless power reception device 110, based on an input (e.g., user input) identified through the keyboard 2010. For example, the accessory device 130 (e.g., the controller 731) may control a modulator (e.g., 733 in FIG. 7), based on a press input onto at least one hardware button included in the keyboard 2010 or a touch input onto at least one software button included in the keyboard 2010, to transmit signals (e.g., data) to the wireless power reception device 110 through a signal transmission/reception coil (e.g., the coil 132). Transmission of signals (e.g., data) from the accessory device 130 to the wireless power reception device 110 may be understood with reference to the descriptions above with reference to FIGS. 15 and 16.

Those skilled in the art will understand that the various example embodiments described herein may be applied organically to each other within the applicable range. For example, those skilled in the art will understand that at least some operations of an embodiment described in the disclosure may be omitted to be applied, or that at least some operations of an embodiment and at least some operations of various embodiments may be organically combined to be applied.

According to an example embodiment, a wireless power reception device (e.g., 110) may include a housing (e.g., 400), a first coil (e.g., 111, 1311, 1321, 1331, 1730, or 1830), and a power processing circuit (e.g., 717) configured to process power wirelessly received from a wireless power transmission device (e.g., 120) through the first coil (e.g., 111, 1311, 1321, 1331, 1730, or 1830). The housing may include a first surface facing a first direction, a second surface facing a second direction opposite the first direction, and a third surface surrounding a space between the first surface and the second the surface. The width of the third surface may be smaller than the width of the first surface. The first coil may be disposed in a region including a region substantially parallel to the third surface.

According to an example embodiment, the wireless power reception device may further include a second coil disposed substantially parallel to the third surface. The wireless power reception device may include a modulator connected to the second coil. The wireless power reception device may include at least one controller comprising control circuitry. At least one controller, individually and/or collectively, may be configured to transmit signals to the outside through the second coil by controlling the modulator.

According to an example embodiment, the wireless power reception device may include a power amplifier connected to the second coil. The second coil may be configured to transmit power to the outside, based on power provided from the power amplifier.

According to an example embodiment, the second coil may be configured to be magnetically coupled to a feed inductor included in the power amplifier and receive power from the power amplifier through the feed inductor.

According to an example embodiment, the wireless power reception device may include a display visible through the first surface of the housing.

According to an example embodiment, a first portion of the first coil, may be disposed substantially parallel to the third surface. A second portion of the first coil may be disposed substantially parallel to the second surface.

According to an example embodiment, the second coil may be disposed at a position spaced apart from the first coil by a specified distance.

According to an example embodiment, the second coil may be disposed in the inner area of the first coil.

According to an example embodiment, the first coil may be disposed in the inner area of the second coil.

According to an example embodiment, a wireless power transmission device may include: a power amplifier, a first coil configured to wirelessly transmit second power to a wireless power reception device, based on first power provided from the power amplifier, a harmonic filter configured to filter the first power provided to the first coil, a secondary inductor magnetically coupled to a resonant inductor included in the harmonic filter, a second coil electrically connected to the secondary inductor and configured to transmit a first signal to the outside, and a modulator connected to the second coil.

According to an example embodiment, the harmonic filter may be configured to filter a secondary harmonic wave of the first power provided to the first coil. The frequency of the first signal transmitted through the second coil may be twice the frequency of second power wirelessly transmitted through the first coil.

According to an example embodiment, the wireless power transmission device may include: a seat 530, 1910, 1920 on which the wireless power reception device or an accessory device is configured to be mounted. The first coil may be disposed substantially parallel to the seat.

According to an example embodiment, the seat 530, 1910, 1920 may include a first seating portion on which a lower side surface of the wireless power reception device is mounted and a second seating portion on which a partial region of a rear surface of the wireless power reception device is mounted. A first portion of the first coil may be disposed substantially parallel to the first seating portion. A second portion of the first coil 121 may be disposed substantially parallel to the second seating portion.

According to an example embodiment, the wireless power transmission device may include a filter configured to filter primary and/or tertiary frequency components of a second signal received from the outside through the second coil.

According to an example embodiment, the wireless power transmission device may include at least one capacitor connected to the first coil. The at least one capacitor and the first coil may be configured to form a resonant circuit.

According to an example embodiment, an accessory device may include a cover configured to cover a first external device, a seat on which the first external device is mounted, a first coil disposed substantially parallel to the seat, a power processing circuit configured to process power wirelessly received from the first external device through the first coil, and a modulator configured to adjust the load connected to the first coil in order for the first external device to recognize a signal.

According to an example embodiment, the width of a surface of the first external device mounted on the seat may be less than the width of a surface of the first external device covered by the cover.

According to an example embodiment, the seat may include a first surface on which the first external device is mounted and facing a first direction, and a second surface facing a second direction opposite the first direction and mounted on a second external device.

According to an example embodiment, the accessory device may include a keyboard. The modulator may be configured to adjust the load connected to the first coil, based on input through the keyboard.

According to an example embodiment, the modulator may be configured to adjust the load connected to the first coil, based on information received from the second external device through the first coil.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium (e.g., internal memory or external memory) that is readable by a machine (e.g., the device). For example, a processor (e.g., the processor) of the machine (e.g., the device) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A wireless power reception device comprising:
a housing;
a first coil; and
a power processing circuit configured to process power wirelessly received from a wireless power transmission device through the first coil,
wherein the housing comprises a first surface facing a first direction, a second surface facing a second direction opposite the first direction, and a third surface surrounding a space between the first surface and the second the surface,
wherein a width of the third surface is smaller than a width of the first surface, and
wherein the first coil is disposed in a region comprising a region substantially parallel to the third surface.

2. The wireless power reception device of claim 1, further comprising:
a second coil disposed substantially parallel to the third surface;
a modulator connected to the second coil; and
at least one controller comprising control circuitry,
wherein at least one controller, individually and/or collectively, is configured to transmit signals to outside through the second coil by controlling the modulator.

3. The wireless power reception device of claim 2, further comprising a power amplifier connected to the second coil,
wherein the second coil is configured to transmit power to outside, based on power provided from the power amplifier.

4. The wireless power reception device of claim 3, wherein the second coil is configured to be magnetically coupled to a feed inductor included in the power amplifier and receive power from the power amplifier through the feed inductor.

5. The wireless power reception device of claim 1, further comprising a display visible through the first surface of the housing.

6. The wireless power reception device of claim 1, wherein a first portion of the first coil is disposed substantially parallel to the third surface, and
wherein a second portion of the first coil is disposed substantially parallel to the second surface.

7. The wireless power reception device of claim 2, wherein the second coil is disposed at a position spaced apart from the first coil by a specified distance.

8. The wireless power reception device of claim 2, wherein the second coil is disposed in an inner area of the first coil.

9. The wireless power reception device of claim 2, wherein the first coil is disposed in an inner area of the second coil.

10. A wireless power transmission device comprising:
a power amplifier;
a first coil configured to wirelessly transmit, based on first power provided from the power amplifier, second power to a wireless power reception device;
a harmonic filter configured to filter the first power provided to the first coil;
a secondary inductor magnetically coupled to a resonant inductor included in the harmonic filter;
a second coil electrically connected to the secondary inductor and configured to transmit a first signal to outside; and
a modulator connected to the second coil.

11. The wireless power transmission device of claim 10, wherein the harmonic filter is configured to filter a secondary harmonic wave of the first power provided to the first coil, and
wherein a frequency of the first signal transmitted through the second coil is twice a frequency of second power wirelessly transmitted through the first coil.

12. The wireless power transmission device of claim 10, further comprising a seat on which the wireless power reception device or an accessory device is configured to be mounted,
wherein the first coil is disposed substantially parallel to the seat.

13. The wireless power transmission device of claim 12, wherein the seat comprises a first seat on which a lower side surface of the wireless power reception device is configured to be mounted and a second seat on which a partial region of a rear surface of the wireless power reception device is configured to be mounted,
wherein a first portion of the first coil is disposed substantially parallel to the first seat, and
wherein a second portion of the first coil is disposed substantially parallel to the second seat.

14. The wireless power transmission device claim 10, further comprising a filter configured to filter primary and/or tertiary frequency components of a second signal received from outside through the second coil.

15. The wireless power transmission device of claim 10, further comprising at least one capacitor connected to the first coil,
wherein the at least one capacitor and the first coil are configured to form a resonant circuit.

16. An accessory device comprising:
a cover configured to cover a first external device;
a seat on which the first external device is configured to be mounted;
a first coil disposed substantially parallel to the seat;
a power processing circuit configured to process power wirelessly received from the first external device through the first coil; and
a modulator configured to adjust a load connected to the first coil such that the first external device recognizes a signal.

17. The accessory device of claim 16, wherein a width of a surface of the first external device mounted on the seat is less than a width of a surface of the first external device covered by the cover.

18. The accessory device of claim 16, wherein the seat comprises a first surface on which the first external device is configured to be mounted and facing a first direction, and a second surface facing a second direction opposite the first direction and configured to be mounted on a second external device.

19. The accessory device of claim 16, further comprising a keyboard,
wherein the modulator is configured to adjust the load connected to the first coil, based on input through the keyboard.

20. The accessory device of claim 18, wherein the modulator is configured to adjust the load connected to the first coil, based on information received from the second external device through the first coil.
